(19) United States
(12) Patent Application Publication
(10) Pub. No.: US 2002/0036794 A1
(43) Pub. Date: Mar. 28, 2002

(54) Method and apparatus for central coordination of data transmission between a transmitting and a receiving network element

(76) Inventors: Bernhard Boehmer, Berlin (DE); Peter Kim, Berlin (DE); Georg Kastelewicz, Berlin (DE); Arnim Vogel, Berlin (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/923,799

(22) Filed: Aug. 8, 2001

(30) Foreign Application Priority Data
Aug. 8, 2000 (EP) 00117012.5

(51) Int. Cl. G06F 15/177; G06F 15/16; G06F 15/173; B41B 1/00; G06F 15/00; G06K 1/00; B41F 1/00; B41J 1/00; H04N 1/00

(52) U.S. Cl. 358/1.15; 709/246; 709/220; 709/226; 709/206; 358/402

(57) ABSTRACT

Terminals and applications which communicate with one another need to agree on a common protocol and data interchange format. Conversion functions are now offered as a separate service for widely differing formats and protocols in the network. Applications no longer need to support every standard, but can use the appropriate conversion service when required. A central entity is introduced in which the available converters register with this entity and store information about the protocols/formats which they can convert to one another. The central entity manages this information and makes it accessible to applications and terminals.

### CLAIM FOR PRIORITY

This application claims priority to European Patent Application No. 00117012.5 filed on Aug. 8, 2000, the disclosure of which is incorporated by reference in its entirety.

### TECHNICAL FIELD OF THE INVENTION

The invention relates to communication in a network using different protocols and/or data interchange formats.

### BACKGROUND OF THE INVENTION

In recent years, commercial information providers have suddenly shown increasing interest in the Internet. This development is due primarily to the flexibility of information interchange, and to the comparatively low costs. For example, the Internet can very easily be used to make information available worldwide quickly and cheaply without the interposition of the central entity, or to offer completely new services. This is based on the distributed communication architecture of the Internet. Standard guidelines are difficult to implement in this case. In the areas of data coding, data transmission and data presentation, this freedom has led to a large number of industry standards or quasi-standards, which have been developed in parallel. This has in turn resulted in products which use different formats and methods for interchanging data and for data representation. Examples of this are applications on Notebooks (PCs), palmtops or mobile telephones, which communicate with one another via the Internet. This trend is being promoted primarily by rapid innovation cycles, the wide range of products, increased specialization and a downward compatibility which is often required in the communication area.

At the moment, every application/terminal provider is forced to support a large number of standards or relevant quasi-standards, in order to achieve compatibility with the products from other manufacturers. Compatibility in this case includes the communication protocols, the formats for the data that are interchanged, and the representation of such data in the terminal. These factors are frequently negotiated at the start of the communication process. FIG. 2 shows the architecture of one such system. Two application types AT1, AT2 and a number of terminals A, B, C are described. The connecting lines within the figure show the data flow. The converters U1a to U2c are responsible for format conversion to match the capabilities of the respective terminal and the application. A characteristic feature of this architecture in this case is that each application has its own converter. Frequently, this is even integrated in the application.

This has resulted in the growth of the combinational problem of a large number of applications in these terminals needing to support an ever greater number of standards for data transmission, coding and presentation. This is very costly for the manufacturers.

For this reason, neither an application nor a terminal can support all the existing standards, for both financial and technical reasons. Each application manufacturer restricts himself/herself to those standards which promise him the greatest turnover. Niche products or older appliances therefore cannot use new applications.

### SUMMARY OF THE INVENTION

In one embodiment of the invention, there is a method for central coordination of data transmission between a transmitting network element and a receiving network element. The method includes, for example, requesting a converter service from a converter coordinator using the transmitting or receiving network element, selecting the converter service using the converter coordinator and performing a data conversion on the data, wherein the transmitting and receiving network elements do not have compatible data or transmission formats.

In one aspect of the invention, the transmitting and/or receiving network element is a terminal.

In another aspect of the invention, the transmitting and/or receiving network element is an application.

In still another aspect of the invention, the method includes sending a report via the converter service to the network element which produced the request.

In yet another aspect of the invention, the method includes sending a report via the converter service to the transmitting network element, to the receiving network element and to the selected conversion service.

In another aspect of the invention, the report includes information about the interchange format to be used by the transmitting and receiving network elements.

In still another aspect of the invention, data is transmitted between the transmitting and receiving network elements via the converter without any further action by the converter coordinator.

In another embodiment of the invention, there is an apparatus for central coordination of data transmission between a transmitting network element and a receiving network element. The apparatus includes, for example, at least one converter which is registered and at least one transmitting or receiving network element which receives a request for a converter service, wherein the apparatus selects one of the at least one registered converters.

In one aspect of the invention, the selected registered converter is sent as a response to the requesting network element.

In another aspect of the invention, the selected registered converter is sent as a response to relevant network elements.

### BRIEF DESCRIPTION OF THE DRAWINGS

The invention will be explained in the following text with reference to exemplary embodiments. In this case, in the figures, in which:

FIG. 1 shows an exemplary system architecture with central converter management.

FIG. 2 shows the architecture of a previous system (prior art).

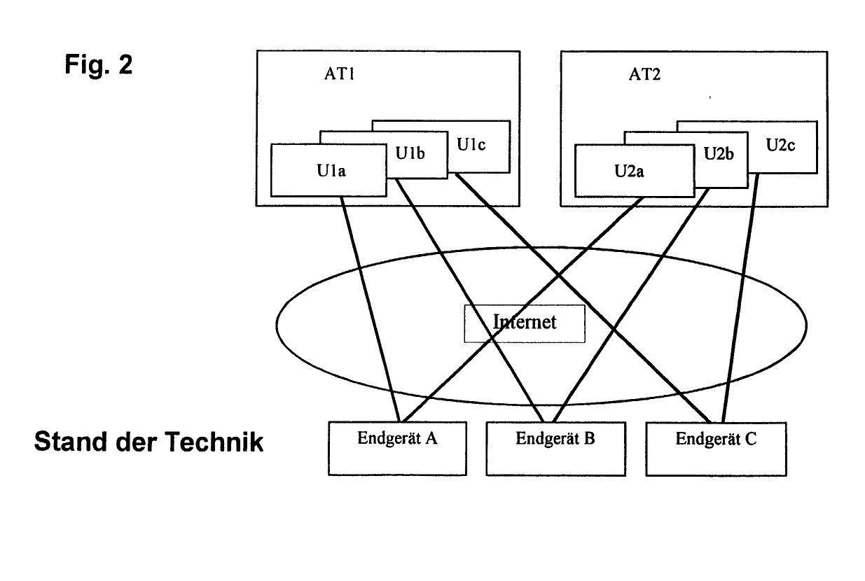

FIG. 3 shows a first example of the information flow between an application, terminal and central entity.

FIG. 4 shows a second example of the information flow between an application, terminal and central entity.

FIG. 5 shows a specific exemplary embodiment.

### DETAILED DESCRIPTION OF THE PREFERRED EMBODIMENTS

The invention specifies a solution for the problems mentioned above. The invention supports a large number of possible applications and terminal types, with a minimal number of converters.

Conversion functions (referred to as media converters in the following text) are, according to the invention, offered as a separate service for widely differing formats and protocols in the network. Applications then no longer need to support every standard, but can use the appropriate conversion service, if required. This shortens the development times and leads to better interoperability with and between terminals from different manufacturers, since each manufacturer does not normally really implement each format.

Terminals and applications which wish to communicate with one another need to agree on a common protocol and data interchange format. In the past, the information which was stored in the terminals was sufficient for this purpose: each terminal knew which protocols and data interchange formats it supported; the selected protocols/data interchange formats had to be within the scope of these selection options. A common protocol or data interchange format was negotiated directly between the respective terminal and the application.

With the provision of converters in the network, it is possible to consider a new dimension in the negotiation of the protocol and data interchange format—the range of available converters and their capabilities for conversion of one protocol or format to another. The terminals/applications do not have this knowledge.

A central entity is therefore introduced in the invention. The available converters register with this entity and store information about the protocols/formats which they can convert to one another. The central entity manages this information and makes it accessible to applications and terminals. The information interchange could, for example, be based on a simple question and answer mechanism, and many implementation options for this purpose are known to persons skilled in the art.

Various scenarios are feasible for negotiation of a common data interchange format between terminals, examples of which are explained in the following text.

An application/terminal makes contact with another terminal/application. After receiving the service request, the terminal or application checks whether its own capabilities are compatible with those of a partner, or whether a converter service is required for information interchange. In the latter case, a terminal then turns to the central entity and requests the provision of a suitable converter.

The central entity:

uses predetermined criteria to select a suitable converter service, and informs the terminal or terminals/application or applications and the converter of the interchange formats. The service communication then takes place directly, without the involvement of the central entity, or

informs the requesting terminal/application of the possible converter services. The terminal/application uses its own criteria to select a suitable converter service, and informs the partner-terminal/partner-application and the converter of the interchange formats.

However, the central entity is not necessarily a universal service provider but a specialized provider of converter services which is autonomously able to select a suitable converter service from a range of converter services, on the basis of criteria. The infrastructure—central entity, media converter, terminals and applications—can be constructed, for example, using the JINI technology.

Some of the advantages of central converter management are:

manufacturers of applications/terminals need no longer support a wide range of standards for data transmission, coding and presentation.

manufacturers of converters and the central entities can—now, since converters are no longer produced exclusively for one application—concentrate on addressing the major area of terminals, which was previously ignored for financial/technical reasons (market range/feasibility).

The management of converters in a central entity in the network (for example, provision by a central entity) makes converters available to applications/terminals. Applications and converters can thus be produced more economically, and can offer a wider range of protocols and data interchange formats that are supported.

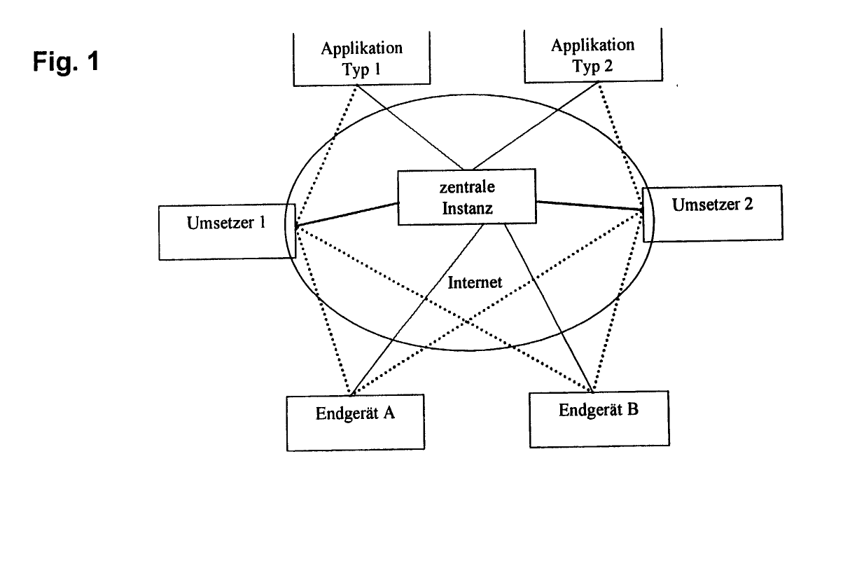

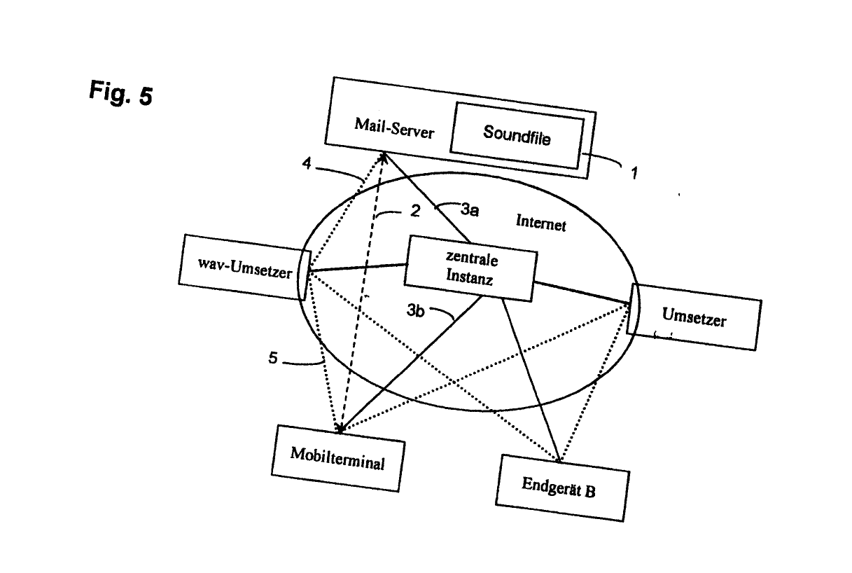

FIG. 1 shows how each converter 1, 2 can be used by a number of applications Typ1, Typ2. The thick lines illustrate the registration relationships to the central entity. The dotted lines indicate the data flow between applications and terminals A, B, each of which includes a converter. A practical application based on the general system architecture and FIG. 5 will be explained in the following text.

In the Internet, the “E-mail” service is offered, which allows documents to be interchanged. In this example, an application Typ1 (a mail server) and a terminal A (for reading and writing the E-mail) are communicating with one another. The E-mail is located on the mail server, for example as an MIME coded (Multipurpose Internet Mail Extensions) ASCII text (American Standard Code for Information Interchange) at 1, and one component of the E-mail (attachment) is a sound file . The terminal may be a mobile terminal which supports the data interchange format WML1.1 (Wireless Markup Language) in accordance with protocol standard WAP 1.1 (Wireless Application Protocol).

The terminal registers with the mail server and finds that new mail has arrived at 2. The terminal decides to download the mail from the mail server. The mail server reports to the terminal that it is necessary to reproduce soundfiles (in accordance with the wav Standard) and to support POP3 (Post office protocol) or FTP (file transfer protocol) for transmission. In this case, the terminal is not able to do this. So, the server and terminal cannot find a common format in which the soundfile could be transmitted from the E-mail by the server to the terminal, and could then be reproduced by that terminal.

The terminal 3b (or the mail server 3a) requests a provision from the central entity. The capabilities of the terminal and mail server are reported to the central entity, including the fact that the terminal is a mobile telephone and supports telephony.

The central entity selects a converter which is able to receive sound files by FTP, to set up telephone connections, and to reproduce said sound files via the voice channel of such a connection.

The mail server transmits the sound file by FTP to the converter at 4, which sets up a telephone connection to the terminal and reproduces the sound file via this connection at 5.

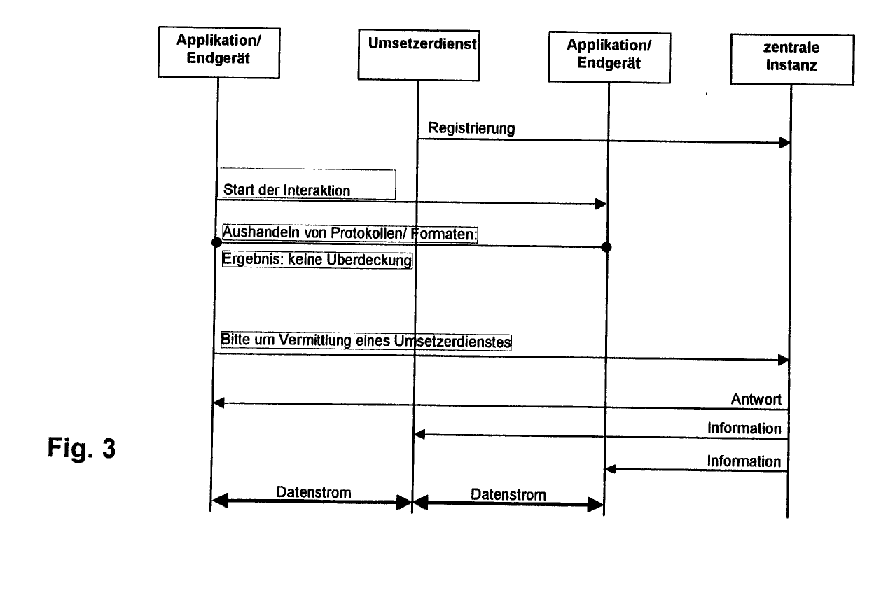

FIG. 3 shows a first example of the message flow between an application, terminal and central entity. A conversion service is registered with the central entity such that data can be interchanged in any desired format between two terminals or applications. First, an attempt is made to interchange such data by direct communication between the terminal/applications. However, if it is determined that the transmission formats are not compatible, the central entity is requested to provide a suitable converter service. The central entity uses the conversion services registered with it to select a suitable service. The central entity then informs each of the units involved. The transmitting application or terminal transmits the data to the conversion service, which converts said data and then passes it on to the receiving application.

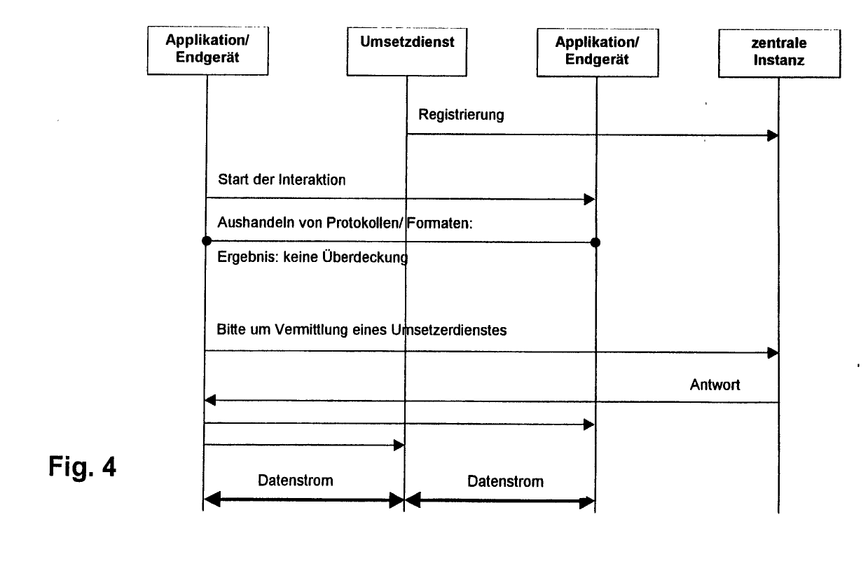

FIG. 4 shows a second example of the information flow between an application, terminal and central entity. The procedure corresponds to that illustrated in FIG. 3. However, the central entity informs the requesting unit, which in turn informs the other units involved: the conversion service and the receiving application or terminal. The transmitting application or terminal transmits the data to the conversion service, which converts such data and then passes it on to the receiving application.

What is claimed is:

1. A method for central coordination of data transmission between a transmitting network element and a receiving network element, comprising:
requesting a converter service from a converter coordinator using the transmitting or receiving network element;
selecting the converter service using the converter coordinator and performing a data conversion on the data, wherein
the transmitting and receiving network elements do not have compatible data or transmission formats.

2. The method as claimed in claim 1, wherein the transmitting and/or receiving network element is a terminal.

3. The method as claimed in patent claim 1, wherein the transmitting and/or receiving network element is an application.

4. The method as claimed in claim 1, further comprising:
sending a report via the converter service to the network element which produced the request.

5. The method as claimed in claim 1, further comprising:
sending a report via the converter service to the transmitting network element, to the receiving network element and to the selected conversion service.

6. The method as claimed claim 1, wherein the report includes information about the interchange format to be used by the transmitting and receiving network elements.

7. The method as claimed in claim 1, wherein data is transmitted between the transmitting and receiving network elements via the converter without any further action by the converter coordinator.

8. An apparatus for central coordination of data transmission between a transmitting network element and a receiving network element, comprising:
at least one converter which is registered; and
at least one transmitting or receiving network element which receives a request for a converter service, wherein
the apparatus selects one of the at least one registered converters.

9. The apparatus as claimed in claim 8, wherein
the selected registered converter is sent as a response to the requesting network element.

10. The apparatus as claimed in claim 8, wherein the selected registered converter is sent as a response to relevant network elements.
